(19) United States
(12) Patent Application Publication
(10) Pub. No.: US 2026/0288089 A1
(43) Pub. Date: Sep. 24, 2026

(54) IDENTIFICATION OF POINT OF FAILURE NODES AND PROACTIVE MITIGATION OF A PREDICTED FAILURE

(71) Applicant: International Business Machines Corporation, Armonk, NY (US)

(72) Inventors: Jennifer M. Hatfield, Portland, OR (US); Carolina Garcia Delgado, Zapopan (MX); Sarbajit Kumar Rakshit, Kolkata (IN); Tushar Agrawal, West Fargo, ND (US)

(21) Appl. No.: 19/087,417

(22) Filed: Mar. 21, 2025

(51) Int. Cl. G05B 13/02

(52) U.S. Cl. CPC G05B 13/0265

(57) ABSTRACT

A digital twin model of a given industrial system is created and a propagation of different services from one point to another point in the given industrial system is identified. An industrial workflow implemented by the given industrial system is analyzed using the identified propagation of different services and different types of points of failure in the given industrial system are identified based on the analyzed industrial workflow. The given industrial system is configured based on the identified points of failure to facilitate mitigation of at least one of the identified points of failure.

### BACKGROUND

The present invention relates generally to the electrical, electronic, and computer arts and, more particularly, to industrial system management and computer-aided manufacturing.

A single point of failure refers to a component, system, or process within a larger system that, if it fails, would result in a failure or disruption of the larger system. It is a vulnerability that poses a significant risk, because there is no backup or redundancy mechanism to take over the functions of the component, system, or process in the event of failure.

### BRIEF SUMMARY

Principles of the invention provide techniques for identification of point of failure nodes and proactive mitigation of a predicted failure. In one aspect, an exemplary method includes the operations of creating a digital twin model of a given industrial system; identifying a propagation of different services from one point to another point in the given industrial system; analyzing an industrial workflow implemented by the given industrial system using the identified propagation of different services; identifying different types of points of failure in the given industrial system based on the analyzed industrial workflow; and configuring the given industrial system based on the identified points of failure to facilitate mitigation of at least one of the identified points of failure.

In one aspect, a computer program product includes one or more tangible computer-readable storage media and program instructions stored on at least one of the one or more tangible computer-readable storage media, the program instructions executable by a processor, the program instructions including creating a digital twin model of a given industrial system; identifying a propagation of different services from one point to another point in the given industrial system; analyzing an industrial workflow implemented by the given industrial system using the identified propagation of different services; identifying different types of points of failure in the given industrial system based on the analyzed industrial workflow; and configuring the given industrial system based on the identified points of failure to facilitate mitigation of at least one of the identified points of failure.

In one aspect, an apparatus includes a memory and at least one processor, coupled to the memory, and operative to perform operations including creating a digital twin model of a given industrial system; identifying a propagation of different services from one point to another point in the given industrial system; analyzing an industrial workflow implemented by the given industrial system using the identified propagation of different services; identifying different types of points of failure in the given industrial system based on the analyzed industrial workflow; and configuring the given industrial system based on the identified points of failure to facilitate mitigation of at least one of the identified points of failure.

As used herein, “facilitating” an action includes performing the action, making the action easier, helping to carry the action out, or causing the action to be performed. Thus, by way of example and not limitation, instructions executing on a processor might facilitate an action carried out by instructions executing on a remote processor, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
identification of single points of failure and mitigation activities to minimize or eliminate the impact of single points of failure;
a digital twin model of an industrial system;
models to predict different “single points of failure” and a time when the failure scenario can occur in the industrial system;
systems that recommend types of mitigation steps for “single points of failure”;
appropriate support backup with one or more civilian robotic manufacturing systems that are proactively configured such that the predicted impact of single points of failure can be minimized or eliminated;
improve the technological process of operating an industrial facility with a computer-implemented method that identifies single points of failure for the industrial facility and facilitates mitigation (e.g., proactive mitigation) of same; and
analysis of the cost of impact due to a failure.

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is an example workflow for determining mitigation steps on an industrial floor based on simulation results when there are different types of “single points of failure,” in accordance with an exemplary embodiment;

FIG. 2 is a first high-level workflow for managing an exemplary industrial floor, in accordance with exemplary embodiments;

FIG. 3 is a second high-level workflow for managing an exemplary industrial floor, in accordance with exemplary embodiments; and

FIG. 4 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

A single point of failure refers to a component, system, or process within a larger system that, if it fails, would result in a failure or disruption of the larger system. Possible impacts of a single point of failure which vary depending on the nature of the system or process involved are listed below. Common impacts of single points of failure vary depending on the nature of the system or process, and include:
the complete shutdown or inoperability of the larger system, leading to significant downtime (this can disrupt operations, cause loss of productivity, and/or result in financial losses);
the failure of a critical component can degrade the performance of the system, leading to slower processing times, decreased efficiency, and/or degraded user experience (this can impact productivity and customer satisfaction);
if a single point of failure occurs in a data storage or backup system, it can result in the loss or corruption of important data (this can have significant consequences for businesses, including loss of pertinent information, regulatory compliance issues, and/or reputational damage);
in certain systems, a single point of failure can pose safety risks (for example, in industrial settings or transportation systems, failure of an important component can lead to accidents or the like);
a single point of failure in a service-oriented system can disrupt the delivery of services to customers (this can impact customer satisfaction, contractual obligations, and/or revenue generation);
a single point of failure can trigger a cascade of subsequent failures in interconnected systems or processes (this domino effect can amplify the overall impact and result in widespread disruptions and/or system failures);
if a single point of failure leads to service disruptions, data breaches, or prolonged downtime, it can damage the reputation of a business or organization (such instances of negative publicity, customer dissatisfaction, and loss of trust can have long-lasting effects); and
the impact of a single point of failure can result in financial losses, including revenue loss due to downtime, costs associated with recovery and repairs, penalties for breach of service level agreements, and/or potential legal liabilities.

Moreover, a single point of failure can have a potentially highly significant impact on an industrial floor or similar environment. Example components and systems of a single point of failure on an industrial floor or the like include:
power supply: the main power supply for the industrial floor can be a single point of failure (if there is a power outage or failure, such a failure can halt operations and impact the functioning of various equipment and systems);
machinery and/or equipment: machinery and/or equipment that is needed for production processes can have single points of failure (if a key machine breaks down or malfunctions, it can disrupt the entire production line, leading to delays and losses);
network infrastructure: the network infrastructure on an industrial floor, including switches, routers, communication cables, and the like, can be single points of failure (if the network infrastructure fails, it can result in loss of connectivity, hinder data transmission, and/or affect communication between different systems or departments);
heating, ventilation and air conditioning (HVAC) systems: HVAC systems are important for maintaining a comfortable and safe working environment in industrial facilities (if the HVAC system fails, it can impact employee comfort, productivity, and potentially compromise the quality of sensitive products or materials);
environmental controls: industrial floors and other industrial environments often require specific environmental conditions, such as temperature, humidity, air quality control, and the like (if the systems responsible for maintaining these conditions fail, it can lead to adverse effects on production processes, equipment, or product quality);
fire suppression systems: fire suppression systems, including sprinklers, fire alarms, and extinguishing systems, are important for industrial safety (if these systems fail or malfunction, it can result in increased fire risk and jeopardize the safety of personnel and assets);
material or component supply: if there is a single source or limited suppliers for critical materials or components used in the production processes, disruptions in the supply chain can lead to delays or a complete shutdown of operations; and
waste management systems: proper waste management systems, including waste disposal, recycling, or hazardous material handling, are vital for industrial floors (failure or breakdown of waste management systems can lead to environmental hazards, regulatory non-compliance, and/or potential health and safety risks).

There are typically one or more point of failure scenarios in any industrial system. While the systems may operate perfectly during normal operating scenarios, there can, however, be significant impacts in operations on, for example, the industrial floor during an exception or failure scenario. Generally, techniques are disclosed that predict an exception/failure scenario and proactively orchestrate mitigation steps, such that the failure scenario on the industrial floor is prevented or otherwise mitigated.

In one or more exemplary embodiments, a digital twin model of the industrial floor is created using, for example, Internet of Things (IoT) feeds (obtained, for example, from sensors), video and/or image analysis, historically gathered execution logs (such as logs from various machines corresponding to the pre-defined different types of manufacturing workflow processes), and the like. One or more exemplary embodiments leverage the digital twin (DT) to create a series of digital simulations, using a mathematical induction process performed on the digital twin model of the industrial floor, to predict different “single points of failure” on the industrial floor. The predicted “single points of failure” can be based, for example, on an acceptable threshold limit of their impact on the industrial floor. Given the teachings herein, the skilled person would be able to adapt known digital twin simulation techniques to create a series of digital simulations, using a mathematical induction process, and to predict different “single points of failure” on the industrial floor.

In one or more exemplary embodiments, the identified “single points of failure” are ranked based on the type and the degree of impact on the industrial floor. (Given the teachings herein, the degree of impact may be determined by the skilled artisan using machine learning in a manner similar to detecting anomalies of the industrial system, as described more fully below.) Accordingly, one or more exemplary embodiments recommend the types of mitigation steps to be performed by learning from historical data and process documentation to minimize the degree of impact of a potential failure. In one or more exemplary embodiments, the frequency of digital twin simulations on the identified “single points of failure” are dynamically scheduled based on the ranking to determine whether a failure is predicted and/or to determine a time when the failure scenario is predicted to happen, so that proactive mitigation can be taken to minimize the impact. (In exemplary embodiments, the time when the failure is predicted to happen is determined using a digital twin simulation. Given the teachings herein, the skilled person would be able to adapt known digital twin simulation techniques to determine the time when the failure is predicted to happen.)

In one or more exemplary embodiments, the digital twin model of the industrial floor is used to identify which nodes, machines, processes, activities, and the like will be impacted based on the predicted types of failure at any “single point of failure.” Accordingly, appropriate backup support using one or more civilian robotic manufacturing systems are proactively configured such that the predicted impact can be minimized or eliminated.

In one or more exemplary embodiments, the costs of impact due to failure are analyzed based on the identified types of “single points of failure” and their relative positions on the industrial floor. (In exemplary embodiments, an optimization algorithm, such as gradient descent, random forest, or the like, is used to determine the cost of the impact in terms of time, currency (money) or both. Given the teachings herein, the skilled person would be able to adapt known techniques to determine the cost of the impact using an optimization algorithm.) Accordingly, the types of modifications/changes that should be performed on the industrial floor to mitigate the failure in the future are recommended. In one or more exemplary embodiments, augmented reality devices, such as wearable glasses, are incorporated to highlight the industrial surrounding where different types of “single points of failure” are present and to display the proposed modifications to mitigate them.

### Process Flow

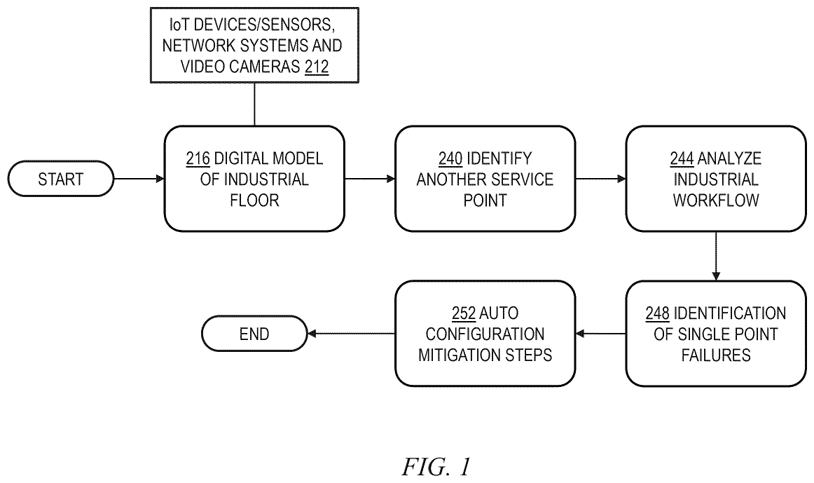

FIG. 1 is an example workflow for determining mitigation steps on an industrial floor based on simulation results when there are different types of “single points of failure,” in accordance with an exemplary embodiment. In the exemplary embodiment, the workflow begins with a method to create a digital twin model of a given industrial floor (operation 216). In one or more exemplary embodiments, IoT data is gathered from various sensors installed in or near different machines, structures, areas of the industrial floor, and the like. The sensors include, for example, temperature sensors, humidity sensors, motion sensors, other relevant IoT devices, and the like. For example, images of the floor are collected using cameras or other visual capture devices. The IoT (or other) devices and/or sensors, network systems, video cameras, and the like are designated generally as 212. Execution logs that provide information about the status, operations, and any errors or abnormalities of machines, and the sequence of operations, communications among the machines, and the like are captured.

In one or more exemplary embodiments, the collected data from the IoT sensors, images, and execution logs are brought together into a centralized data repository or platform using data integration. In one or more exemplary embodiments, this integration involves data pre-processing, cleaning, and synchronization to ensure that the data is in a consistent and usable format. The data pre-processing, cleaning, and synchronization ensure, for example, usability for AI predictions as follows:
integration of data sources—data is gathered from IoT sensors, cameras, and execution logs from machines (these diverse data formats are centralized into a single repository or platform);
data pre-processing—this involves organizing and standardizing data to ensure it is in a consistent format (this may include tasks like converting different file types, normalizing numerical data, unifying timestamps, and the like);
data cleaning—this process eliminates errors, outliers, irrelevant data, and the like to improve quality (for instance, erroneous sensor readings or incomplete execution logs are identified and corrected or discarded);
data synchronization—data from different sources is aligned based on temporal and spatial dimensions, ensuring that sensor readings, images, and execution logs are coherent and can be correlated effectively; and
outcome—the processed, cleaned and synchronized data is structured into a usable format for creating a digital twin model, performing simulations, and making subsequent AI-driven predictions to identify and mitigate potential failures.

Computer vision models are used for analyzing video and image data from cameras to capture the industrial floor's physical layout and monitor processes in real-time. IoT data analysis is used to process and interpret data streams from IoT sensors, including temperature, humidity, motion, and other relevant readings. Time-series analysis is used for processing execution logs and analyzing sequential machine operations, error patterns, and process dependencies. Simulation and mathematical induction models are used to conduct digital simulations of workflows and predict failure scenarios through iterative scenario and dynamic impact analysis.

The collected data is mapped to the corresponding physical locations on the industrial floor. This involves associating the sensor data, images, and execution logs with specific areas, machines, or equipment within the floor layout.

In one or more exemplary embodiments, computer-aided design (CAD) software, specialized 3D modelling techniques, virtual reality (VR) systems, and the like are used to create a digital representation of the industrial floor. The floor model should accurately depict the layout, dimensions, structural details, and the like of the physical floor.

The IoT sensor data and execution logs are incorporated into the digital twin model. In one or more exemplary embodiments, this involves visualizing sensor readings as overlays on the floor model or attaching them to specific objects or equipment within the model. Similarly, the execution logs are overlayed as annotations or indicators on the relevant machines or equipment in the digital twin model.

In one or more exemplary embodiments, real-time monitoring of IoT sensor data and execution logs within the digital twin model are enabled. Analytics or visualization tools are implemented to analyze the data and provide insights into the floor's operations, performance, anomalies and the like. This can help identify patterns, optimize processes, and detect potential issues or failures.

Once the digital twin model is created from the captured data, different machines and systems that are generating/supplying/supporting/transmitting different services/utilities to different locations are identified. In example embodiments, the systems include:
power supplies;
machinery or equipment;
network infrastructure;
HVAC systems;
environmental controls;
fire suppression systems;
material or component supply; and
waste management systems.

In one or more exemplary embodiments, the propagation of different services from one point to another point (including power, environment control and the like) is identified (operation 240). Industrial workflow, IoT feeds, and/or manual feeds can be used for mapping out the layout of the industrial floor, including the location of the power source, other utility connections, and the like. Based on the created digital twin model of the industrial floor, different utilities/services (such as the main power supply lines, distribution panels, and subpanels throughout the floor) will be identified. The routing and branching of utility lines from the source to various areas or equipment are identified based on the created digital twin model. Based on the created digital twin model, the sources of different services/utilities, and how the services or utility services are provided to different nodes/locations of the industrial floor, are identified. Using the IoT, execution logs from various machines, and how different other machines, modes and the like are receiving the services are identified and a mode is created. Digital twin simulations using random forest techniques will produce an optimal simulation with the smallest number of failures and describing, for example, which machines should be collocated. Given the teachings herein, the skilled person would be able to configure digital twin simulations using random forest techniques to produce an optimal simulation. Modes refers to an operational state or method through which services, utilities, processes and the like are received or executed by machines or components within the industrial system. Examples of models include a machine receiving power directly from the main supply (direct mode); a backup generator mode triggered during a power outage; sequential mode of machines; and parallel mode of machines.

In one or more exemplary embodiments, the industrial workflow is analyzed (operation 244). Based on a predefined workflow about different manufacturing processes, or identified execution workflow, dependencies and the like, how the utility/services will be provided from one location on the industrial floor to another location is determined and identified. The dependencies from one machine to another machine while executing the industrial workflow are identified. The magnitude of services/utilities provided from one location to another location on the industrial floor are identified.

In one or more exemplary embodiments, different types of “single points of failure” on the industrial floor are identified (operation 248). Digital simulations of industrial workflows are performed and, utilizing mathematical induction, a series of digital twin simulations are performed by, for example, enabling and disabling different identified sources of utilities/services. Industrial workflows, including process steps, dependencies, resource utilization, failure points and the like, are captured. This information can come from historical records, process documentation, and insights from subject matter experts. The identified locations of the sources and utilities, their respective magnitudes, and the mapping of the industrial activities are used.

Mathematical induction is used in this context as a methodical approach to validate system behaviors over a sequence of scenarios systematically. This allows the exemplary system to predict industrial failures as it gradually builds the digital twin model using IoT feeds, image analysis, and historical logs. By enabling and disabling utilities/services in the model, the exemplary system simulates workflows to detect “single points of failure.” The simulations explore how disruptions propagate through interconnected systems. Using inductive reasoning, recurring patterns are identified, enabling ranking of “single points of failure” by the severity of the impact.

Based on the digitally created process model and the identified mapping of the sources of the services/utilities, a digital representation of the industrial workflow is created. This representation could be presented to the user as an interactive visualization reproducing additional simulations. In example embodiments, a machine learning model, such as a random forest model, is fed the relevant machine specifications, video feeds, IoT data, sensor data and the like and the model identifies anomalies of the industrial system. For example, the model can identify a machine which is not being fed sufficient intake materials to operate at full capacity. In example embodiments, the same data is fed into another machine learning model to generate a suggestion(s) to mitigate the anomaly, such as adding a parallel machine to generate additional intake material for the machine operating under capacity.

Different types of failure scenarios are integrated into the simulation using mathematical induction methods and, during introduction of the failure, different magnitudes of failure on the identified sources of services/utilities are created. While executing the simulation, different combinations and types of failures in the model are introduced and a final result is evaluated. In this case, different types of failure scenarios are integrated into the simulation and, during introduction of the failure, different magnitudes of failure on the identified sources of services/utilities are created. During mathematical induction-based simulation, a binomial coefficient is used and one or more failures in the sources of the utilities/services are added to view the simulation results:
C(n, R)=N!/(r!(n-R)!) Where:
C(n, r) represents the number of combinations of selecting r elements from a set of n elements;
n denotes the number of identified sources of utilities/services; and
r denotes the number of failures selected for any mathematical induction.

Based on the final results after the simulation of the various combinations, the sources of services/utilities that can create a major impact (if any failure is detected) are identified.

Based on the threshold level of impact determined by comparing the final results, the sources of utilities/services that are “single points of failure” are identified. The potential single points of failure within the manufacturing workflow are ranked based on the degree of their overall impact.

In one or more exemplary embodiments, the industrial floor is auto-configured based on a detected “single point of failure” (operation 252). Based on the ranking and the predefined rules, a frequency of a digital twin simulation on the identified “single point of failure” is selected; for example, the highest magnitude impact for any “single point of failure” needs frequent (such as daily, hourly and the like) digital twin simulation. The “single points of failure” are configured so that, in a timely fashion, digital twin simulation is performed such that appropriate proactive action can be taken. Different types of mitigation steps are implemented on the industrial floor; based on the identified types of “single points of failure,” appropriate mitigation is applied.

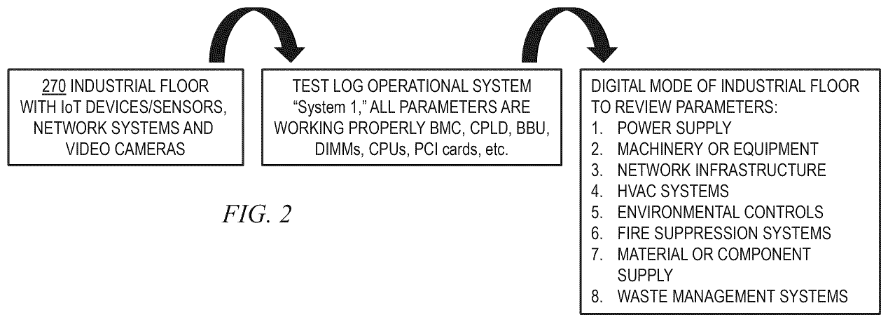

FIG. 2 is a first high-level workflow for managing an exemplary industrial floor, in accordance with exemplary embodiments. An industrial floor 270 includes IoT devices/sensors, network systems, video cameras and the like. The parameters on the industrial floor are checked for proper operation via a test log (operational system). For example, the validity of the parameters of printers, bulk chilling machines (BMCs), complex programmable logic devices (CPLD), baseband units (BBU), dual inline memory modules (DIMMs), central processing units (CPUs), peripheral component interconnect (PCI) cards, and the like are checked.

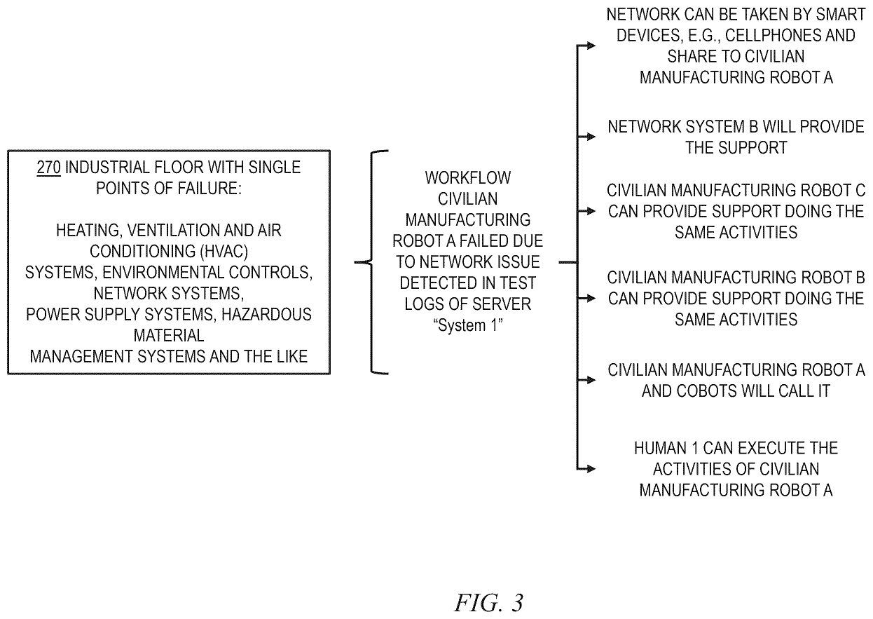

FIG. 3 is a second high-level workflow for managing an exemplary industrial floor, in accordance with exemplary embodiments. Single points of failure on the industrial floor 270 may include heating, ventilation and air conditioning (HVAC) systems, environmental controls, network systems, power supply systems, hazardous material management systems and the like. In the example of FIG. 3, a civilian manufacturing robot A has failed due to a network issue detected in test logs of a given server. Various mitigation actions may be performed in response to the detected point of failure, as illustrated in FIG. 3.

Given the discussion thus far, it will be appreciated that, in general terms, an exemplary method, according to an aspect of the invention, includes the operations of creating a digital twin model of a given industrial system (operation 216); identifying a propagation of different services from one point to another point in the given industrial system (operation 240); analyzing an industrial workflow implemented by the given industrial system using the identified propagation of different services (operation 244); identifying different types of points of failure in the given industrial system based on the analyzed industrial workflow (operation 248); and configuring the given industrial system based on the identified points of failure to facilitate mitigation of at least one of the identified points of failure (operation 252).

In one aspect, a computer program product includes one or more tangible computer-readable storage media and program instructions stored on at least one of the one or more tangible computer-readable storage media, the program instructions executable by a processor, the program instructions including creating a digital twin model of a given industrial system (operation 216); identifying a propagation of different services from one point to another point in the given industrial system (operation 240); analyzing an industrial workflow implemented by the given industrial system using the identified propagation of different services (operation 244); identifying different types of points of failure in the given industrial system based on the analyzed industrial workflow (operation 248); and configuring the given industrial system based on the identified points of failure to facilitate mitigation of at least one of the identified points of failure (operation 252).

In one aspect, a system includes a memory and at least one processor, coupled to the memory, and operative to perform operations including creating a digital twin model of a given industrial system (operation 216); identifying a propagation of different services from one point to another point in the given industrial system (operation 240); analyzing an industrial workflow implemented by the given industrial system using the identified propagation of different services (operation 244); identifying different types of points of failure in the given industrial system based on the analyzed industrial workflow (operation 248); and configuring the given industrial system based on the identified points of failure to facilitate mitigation of at least one of the identified points of failure (operation 252).

In exemplary embodiments, the points of failure include single points of failure.

In exemplary embodiments, data is gathered from sensors installed across the given industrial system, images of the given industrial system are collected using visual capture devices; and execution logs that provide information about a status, operations and abnormalities of machines and infrastructure of the given industrial system and sequences of operations and communications across the given industrial system are captured, and the creating the digital twin model is based on the gathered data, the collected images and the execution logs.

In exemplary embodiments, integration of data resulting from the gathering of the data, the collecting of the images and the capturing of the execution logs is performed, the data integration including data pre-processing and synchronization to ensure that the integrated data is in a consistent and usable format for creating the digital twin model; and data of the digital twin model is mapped to corresponding physical locations of the given industrial system to facilitate analysis of the industrial system.

In exemplary embodiments, the mapping of the data of the digital twin model to the corresponding physical locations is performed by associating the sensor data, the images, and the execution logs with specific elements of a layout of the given industrial system; and a digital representation of the given industrial system is created using modelling techniques to facilitate the analysis of the industrial system.

In exemplary embodiments, the sensor data and execution logs are incorporated into the digital twin model, the sensor data is visualized as overlays on the digital representation of the digital twin model, the sensor data is attached to corresponding elements of the given industrial system and portions of the execution logs are overlayed as annotations on elements of the given industrial system. This aspect can be used to provide a variety of practical applications, such as displaying pertinent information to a maintenance person or the like via augmented reality goggles or the like, so that the maintenance person can carry out one or more maintenance actions.

In exemplary embodiments, the identifying of the propagation of the different services is further based on the created digital twin model of the given industrial system and a layout of the given industrial system is mapped, the layout including a location of a power source and utility connections, using an implemented industrial workflow.

In exemplary embodiments, the identifying of the propagation of the different services from one point to another point in the given industrial system further includes identifying dependencies between machines of the given industrial system and identifying a magnitude of services and utilities provided from one location to another location of the given industrial system.

In exemplary embodiments, a series of digital twin simulations is performed utilizing mathematical induction by enabling and disabling different identified sources of utilities and services, and the configuring of the given industrial system is based on the digital twin simulations.

In exemplary embodiments, different types of failure scenarios are integrated into the digital twin simulations using the mathematical induction and, during the integration of the different types of failure scenarios, different magnitudes of failure on the identified sources of services and utilities are created, wherein the configuring of the given industrial system is based on the created different magnitudes of failure.

In exemplary embodiments, while executing the digital twin simulations, different combinations and types of failures are introduced in the digital twin model and a final result of the digital twin simulations is evaluated, wherein the configuring of the given industrial system is based on the final result.

In exemplary embodiments, during the mathematical induction-based digital twin simulations, a binomial coefficient is used and one or more failures in sources of utilities and services are added to view results of the digital twin simulations based on:
C(n, r)=n!/(r!(n-r)!) where:
C(n, r) represents a number of combinations of selecting r elements from a set of n elements;
n denotes a number of the sources of utilities and services; and
r denotes a number of failures selected for any mathematical induction.

In exemplary embodiments, a location of at least one of the single point of failures in the given industrial system is detected and the sources of the services and utilities that can create a major impact are identified based on final results of various combinations of simulation in response to detecting the location of the at least one of the single point of failures.

In exemplary embodiments, sources of utilities and services that are single points of failure are identified based on a threshold level of impact determined by comparing final results of the digital twin simulations; and the single points of failure within a manufacturing workflow are ranked based on a degree of overall impact.

In exemplary embodiments, the single points of failure are ranked based on their impact on the given industrial system and a frequency of the digital twin simulations on the identified single points of failure is selected based on the ranking and predefined rules.

In exemplary embodiments, one or more mitigation steps in the industrial system are implemented based on the identified sources of single points of failure and by learning from historical data and process documentation to minimize a degree of impact of a potential failure.

In exemplary embodiments, costs of impact due to failure are analyzed based on the identified sources of single points of failure and their relative positions in the given industrial system, wherein the implementing of the mitigation is based on the analyzed costs.

.In exemplary embodiments, the mitigation is selected from the group consisting of: adding a second machine to the industrial system to increase the intake to a first machine, slowing a production of a third machine in the industrial system to decrease the intake to the first machine, adding cooling technology to a given machine of the industrial system to mitigate overheating of the given machine, adding heating technology to the given machine of the industrial system to mitigate overcooling of the given machine, and dispatching a technician to implement the mitigation, wherein the technician utilizes augmented reality goggles to view sensor data.

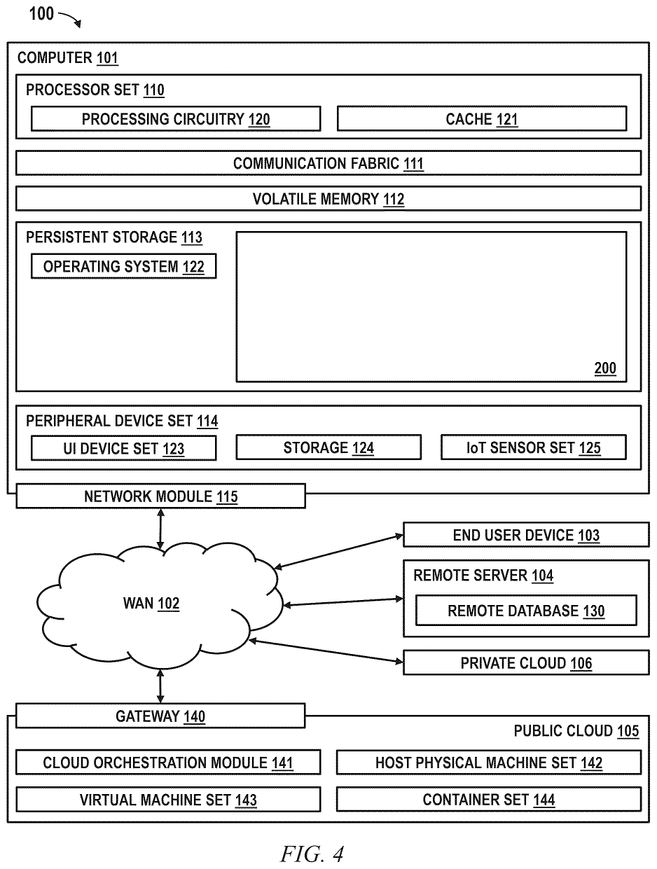

Refer now to FIG. 4.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as failure detection and mitigation system 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
creating a digital twin model of a given industrial system;
identifying a propagation of different services from one point to another point in the given industrial system;
analyzing an industrial workflow implemented by the given industrial system using the identified propagation of different services;
identifying different types of points of failure in the given industrial system based on the analyzed industrial workflow; and
configuring the given industrial system based on the identified points of failure to facilitate mitigation of at least one of the identified points of failure.

2. The computer-implemented method of claim 1, wherein the points of failure comprise single points of failure.

3. The computer-implemented method of claim 2, further comprising:
gathering data from sensors installed across the given industrial system;
collecting images of the given industrial system using visual capture devices; and
capturing execution logs that provide information about a status, operations and abnormalities of machines and infrastructure of the given industrial system and sequences of operations and communications across the given industrial system, and wherein the creating the digital twin model is based on the gathered data, the collected images and the execution logs.

4. The computer-implemented method of claim 3, further comprising:
performing data integration of data resulting from the gathering of the data, the collecting of the images and the capturing of the execution logs, the data integration comprising data pre-processing and synchronization to ensure that the integrated data is in a consistent and usable format for creating the digital twin model; and
mapping data of the digital twin model to corresponding physical locations of the given industrial system to facilitate analysis of the industrial system.

5. The computer-implemented method of claim 4, wherein the mapping of the data of the digital twin model to the corresponding physical locations is performed by associating the sensor data, the images, and the execution logs with specific elements of a layout of the given industrial system; and further comprising:
creating a digital representation of the given industrial system using modelling techniques to facilitate the analysis of the industrial system.

6. The computer-implemented method of claim 5, further comprising:
incorporating the sensor data and execution logs into the digital twin model;
visualizing the sensor data as overlays on the digital representation of the digital twin model;
attaching the sensor data to corresponding elements of the given industrial system; and
overlaying portions of the execution logs as annotations on elements of the given industrial system.

7. The computer-implemented method of claim 2, wherein the identifying of the propagation of the different services is further based on the created digital twin model of the given industrial system and further comprises mapping a layout of the given industrial system, the layout comprising a location of a power source and utility connections, using an implemented industrial workflow.

8. The computer-implemented method of claim 2, wherein the identifying of the propagation of the different services from one point to another point in the given industrial system further comprises:
identifying dependencies between machines of the given industrial system; and
identifying a magnitude of services and utilities provided from one location to another location of the given industrial system.

9. The computer-implemented method of claim 2, further comprising performing a series of digital twin simulations utilizing mathematical induction by enabling and disabling different identified sources of utilities and services and wherein the configuring of the given industrial system is based on the digital twin simulations.

10. The computer-implemented method of claim 9, further comprising:
integrating different types of failure scenarios into the digital twin simulations using the mathematical induction; and
creating, during the integration of the different types of failure scenarios, different magnitudes of failure on the identified sources of services and utilities, wherein the configuring of the given industrial system is based on the created different magnitudes of failure.

11. The computer-implemented method of claim 9, further comprising introducing, while executing the digital twin simulations, different combinations and types of failures in the digital twin model and evaluating a final result of the digital twin simulations, wherein the configuring of the given industrial system is based on the final result.

12. The computer-implemented method of claim 9, further comprising using, during the mathematical induction-based digital twin simulations, a binomial coefficient and adding one or more failures in sources of utilities and services to view results of the digital twin simulations based on:
C(n, r)=n!/(r!(n-r)!) where:
C(n, r) represents a number of combinations of selecting r elements from a set of n elements;
n denotes a number of the sources of utilities and services; and
r denotes a number of failures selected for any mathematical induction.

13. The computer-implemented method of claim 12, further comprising:
detecting a location of at least one of the single point of failures in the given industrial system; and
identifying the sources of the services and utilities that can create a major impact based on final results of various combinations of simulation in response to detecting the location of the at least one of the single point of failures.

14. The computer-implemented method of claim 9, further comprising
identifying sources of utilities and services that are single points of failure based on a threshold level of impact determined by comparing final results of the digital twin simulations; and
ranking the single points of failure within a manufacturing workflow based on a degree of overall impact.

15. The computer-implemented method of claim 9, further comprising
ranking the single points of failure based on their impact on the given industrial system; and
selecting a frequency of the digital twin simulations on the identified single points of failure based on the ranking and predefined rules.

16. The computer-implemented method of claim 2, further comprising implementing one or more mitigation steps in the industrial system based on:
the identified sources of single points of failure; and
by learning from historical data and process documentation to minimize a degree of impact of a potential failure.

17. The computer-implemented method of claim 16, further comprising analyzing costs of impact due to failure based on the identified sources of single points of failure and their relative positions in the given industrial system, wherein the implementing of the mitigation is based on the analyzed costs.

18. The computer-implemented method of claim 2, wherein the mitigation is selected from the group consisting of: adding a second machine to the industrial system to increase the intake to a first machine, slowing a production of a third machine in the industrial system to decrease the intake to the first machine, adding cooling technology to a given machine of the industrial system to mitigate overheating of the given machine, adding heating technology to the given machine of the industrial system to mitigate overcooling of the given machine, and dispatching a technician to implement the mitigation, wherein the technician utilizes augmented reality goggles to view sensor data.

19. A computer program product, comprising:
one or more tangible computer-readable storage media and program instructions stored on at least one of the one or more tangible computer-readable storage media, the program instructions executable by a processor, the program instructions comprising:
creating a digital twin model of a given industrial system;
identifying a propagation of different services from one point to another point in the given industrial system;
analyzing an industrial workflow implemented by the given industrial system using the identified propagation of different services;
identifying different types of points of failure in the given industrial system based on the analyzed industrial workflow; and
configuring the given industrial system based on the identified points of failure to facilitate mitigation of at least one of the identified points of failure.

20. A system comprising:
a memory; and
at least one processor, coupled to the memory, and operative to perform operations comprising:
creating a digital twin model of a given industrial system;
identifying a propagation of different services from one point to another point in the given industrial system;
analyzing an industrial workflow implemented by the given industrial system using the identified propagation of different services;
identifying different types of points of failure in the given industrial system based on the analyzed industrial workflow; and
configuring the given industrial system based on the identified points of failure to facilitate mitigation of at least one of the identified points of failure.
